(19) United States
(12) Patent Application Publication
(10) Pub. No.: US 2026/0304232 A1
(43) Pub. Date: Oct. 1, 2026

(54) OPERATING A TELECOMMUNICATIONS NETWORK COMPRISING A RADIO ACCESS NETWORK

(71) Applicant: Deutsche Telekom AG, Bonn (DE)

(72) Inventor: Axel Klatt, Cologne (DE)

(21) Appl. No.: 19/479,743

(22) PCT Filed: Apr. 25, 2024
(86) PCT No.: PCT/EP2024/061489

§ 371 Date: Oct. 29, 2025

(30) Foreign Application Priority Data
May 4, 2023 (EP) 23171685.3

(51) Int. Cl. H04W 28/18; H04W 92/20

(52) U.S. Cl. CPC H04W 28/18; H04W 92/20

(57) ABSTRACT

A radio access network of a telecommunications network comprises a plurality of radio access network nodes that are configured to interact in order to provide communication services to user equipments connected to or served by the telecommunications network. The radio access network nodes realize, at least partly, radio access coordinator unit functionalities and/or base station functionalities. In order to operate the telecommunications network and/or the radio access network and in order for a specific first radio access network node and a specific second radio access network node to interact with each other, the following steps are performed: the specific first radio access network node sends a capability indication message, wherein the capability indication message comprises capability information related to or indicating a capability of the specific first radio access network node; and the specific second radio access network node receives the capability information.

### CROSS-REFERENCE TO PRIOR APPLICATIONS

This application is a U.S. National Phase application under 35 U.S.C. § 371 of International Application No. PCT/EP2024/061489, filed on Apr. 25, 2024, and claims benefit to European Patent Application No. EP 23171685.3, filed on May 4, 2023. The International Application was published in English on Nov. 7, 2024 as WO 2024/227697 A1 under PCT Article 21(2).

### FIELD

The present invention relates a method for operating a telecommunications network comprising a radio access network, wherein the radio access network comprises a plurality of radio access network nodes that are able to interact in order to provide communication services to user equipments being connected to or served by the telecommunications network, wherein the radio access network nodes realize, at least partly, radio access coordinator unit functionalities and/or base station functionalities.

Furthermore, the present invention relates to a system or to a telecommunications network for operating the telecommunications network comprising a radio access network, wherein the radio access network comprises a plurality of radio access network nodes that are able to interact in order to provide communication services to user equipments being connected to or served by the telecommunications network, wherein the radio access network nodes realize, at least partly, radio access coordinator unit functionalities and/or base station functionalities.

Furthermore, the present invention relates to a program and to a computer-readable medium for operating a telecommunications network comprising a radio access network according to exemplary embodiments of the inventive method.

The present invention relates to the area of telecommunications networks, especially wireless telecommunications networks or mobile communication networks.

### BACKGROUND

Conventional telecommunications networks or mobile communication networks predominantly are or comprise monolithic blocks from a single vendor—especially regarding network infrastructure, and particularly with regard to the radio access network and base station entities.

In conventional telecommunications networks or mobile communication networks, the classical approach is that each (monolithic) vendor of the next-generation radio access network (NG-RAN) supplies their own proprietary operation and maintenance system (O&M system).

A consistent configuration between the different neighboring nodes of the next-generation radio access network is prerequisite for error-free interworking and consistent behavior across vendor boundaries in real network deployments. This consistency is typically ensured by the respective mobile operators (of the considered telecommunications networks) who request certain functionality of the next-generation radio access network from multiple vendors, integrate and test the functionalities and perform a consistent configuration in the different (e.g., vendor-specific) O&M systems.

Likewise, in the context of the open network automation platform (ONAP) that is proposing automation, orchestration and management systems, the responsibility for ensuring consistency (regarding the interworking of different network nodes, especially of or associated with the radio access network, provided by different vendors) lies with the mobile network operators.

However, ensuring such consistency becomes more and more complicated in case of more diverse multi-vendor radio access network implementations, especially next-generation radio access networks.

### SUMMARY

In an exemplary embodiment, the present application provides a method for operating a telecommunications network comprising a radio access network. The radio access network comprises a plurality of radio access network nodes that are configured to interact in order to provide communication services to user equipments connected to or served by the telecommunications network. The radio access network nodes realize, at least partly, radio access coordinator unit functionalities and/or base station functionalities. In order to operate the telecommunications network and/or the radio access network and in order for a specific first radio access network node and a specific second radio access network node to interact with each other, the method comprises the following steps: in a first step, the specific first radio access network node sends a capability indication message, wherein the capability indication message comprises capability information related to or indicating a capability of the specific first radio access network node; and in a second step, the specific second radio access network node receives the capability information.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically illustrates a telecommunications network comprising an access network, a core network and a user equipment, wherein the core network comprises a number of network functions or services, and wherein the (radio) access network likewise comprises a number of base station entities providing radio coverage for specific geographical areas, respectively.

FIG. 2 schematically illustrates different interfaces or reference points between network nodes or parts of the core network of the telecommunications network as well as network nodes or parts of the radio access network (radio access network nodes) of the telecommunications network.

FIG. 3 schematically illustrates an example of a base station entity, representing different functional entities or functionalities (or radio access network nodes) of the base station entity in order to provide communication services to user equipments connected to or served by the telecommunications network.

FIGS. 4 and 5 schematically illustrate different communication situations between two radio access network nodes of the radio access network of the telecommunications network.

### DETAILED DESCRIPTION

Exemplary embodiments of the present invention provide an effective and simple approach for operating a telecommunications network comprising a radio access network such that a plurality of radio access network nodes—that are able to interact in order to provide communication services to user equipments being connected to or served by the telecommunications network—are enabled to implement such interaction, despite being provided by different vendors, in a more efficient, less error-prone as well as more automatic manner. Further exemplary embodiments of the present invention provide a corresponding system or telecommunications network, and a corresponding program and computer-readable medium.

In an exemplary embodiment, the present invention provides a method for operating a telecommunications network comprising a radio access network, wherein the radio access network comprises a plurality of radio access network nodes that are able to interact in order to provide communication services to user equipments being connected to or served by the telecommunications network,

wherein the radio access network nodes realize, at least partly, radio access coordinator unit functionalities and/or base station functionalities,
wherein, in order to operate the telecommunications network and/or the radio access network and in order for a specific first radio access network node and a specific second radio access network node interacting with each other, the method comprises the following steps:
in a first step, the specific first radio access network node sends a capability indication message, the capability indication message comprises capability information related to or indicating the capability of the specific first radio access network node,
in a second step, the specific second radio access network node receives capability information related to the specific first radio access network node.

It is thereby advantageously possible, according to the present invention, that a dynamic capability exchange is possible over different interfaces (between radio access network nodes realizing, at least partly, radio access coordinator unit functionalities and/or base station functionalities), and this especially in a disaggregated radio access network. Only exemplarily, in the following especially the specific first radio access network node and the specific second radio access network node, or their interaction, is specifically considered in order to explain, in a detailed manner, how such interaction or communication, between such radio access network nodes, is able to be performed according to different embodiments of the present invention in order to operate the telecommunications network and/or the radio access network in view of serving the user equipment with communication services and especially in order to exchange, or to transmit, capability information from one radio access network node to another (especially neighboring) radio access network node, as well as vice versa in a rather automatic manner and especially without the need for a manual interaction or configuration of proprietary operation and maintenance systems related only to network nodes provided by one single supplier of network infrastructure equipment, e.g. base station entities or components thereof.

In such a manner, it is advantageously possible, according to the present invention, the configuration information or capability information is transmitted and/or exchanged between radio access network nodes (i.e. capability information regarding the capabilities (or regarding the current or future state thereof) of the respective network node transmitting (or sending) such capability information) that are required to interact in view of serving the user equipment with communication services—such requirement for interaction of such radio access network nodes, e.g., resulting from their geographical vicinity and/or from their functional relationship.

According to the present invention, it is, hence, advantageously possible to provide for a consistent—and, especially, up-to-date—configuration between the different (especially neighboring) radio access network nodes of the next-generation radio access network, and this especially across vendor boundaries in real network deployments, i.e. regarding radio access network nodes being provided by different—if not even a multitude—of suppliers; furthermore, such a consistent configuration among such—potentially heterogeneous (i.e. of different suppliers or vendors, and providing different functionalities at potentially different layers)—radio access network nodes is able to be obtained, according to the present invention, in an automatic (or rather automatic or automated) manner, i.e. either completely automatically or, at least, in a manner such that no profound or detailed configuration skills are required in order to trigger such exchange of capability information, e.g., in view of adding or removing or modifying a radio access network node as part of the telecommunications network or radio access network. For example, it might be required—in order to start a network node or in order to add a network node—to somehow activate an autoconfiguration or startup procedure, e.g. via pushing a button or the like, but not an in-depth review or consideration of the network node's configuration.

According to the present invention, a multitude of different mechanisms or manners to transmit or send—by a specific first radio access network node—such capability information (relating to the specific first radio access network node) to a specific second radio access network node (and, of course, also vice versa in order to assure the mentioned consistent configuration) is contemplated and suggested, including (but not limited to) a flexible direct (capability) information exchange or via a repository or inventory network function or service (e.g. a radio access network inventory and capability network function RANICNF).

Especially according to the present invention, this exchange (or transmission) of capability information is structured according to different interfaces or reference points (i.e. capabilities or capability information relating to (capabilities on or using) specific interfaces or reference points are preferably grouped (or transmitted in a structured or coordinated manner), e.g. regarding interfaces such as the Uu interface towards the user equipments, the NG interface towards (network functions or services of) the core network and the Xn interface between radio access network nodes of the NG-RAN.

According to the present invention, it is advantageously possible and preferred that, as part of the second step, the specific second radio access network node receives the capability indication message sent by the specific first radio access network node, wherein, especially, the specific second radio access network node sends, prior to the first step, a capability indication request message to the specific first radio access network node, wherein, especially, the specific first radio access network node sends the capability indication message upon detecting the presence of the specific second radio access network node or as a generic multicast message or as a broadcast message, especially periodically.

Via the specific second radio access network node receiving the capability indication message (sent by the specific first radio access network node), it is advantageously possible to provide for a rather direct communication (and exchange of capability information) from the specific first radio access network node to the specific second radio access network node. Via a capability indication request message (sent by the specific second radio access network node) and/or via presence detection and/or broadcasting (or multicasting), advantageous variations of such a direct communication lead to the possibility to advantageously perform exemplary embodiments of the inventive method in a flexible and efficient manner.

According to the present invention, it is furthermore advantageously possible and preferred that, as part of the first step, a central database entity or functionality receives the capability indication message sent by the specific first radio access network node, wherein, as part of the second step, the capability information related to the specific first radio access network node is received, by the specific second radio access network node, from the central database entity or functionality,

wherein especially the central database entity or functionality is or corresponds to a radio access network inventory and/or capability network function.

Via using a rather centralized database entity or functionality for transmitting the capability information (from one radio access network node to another radio access network node), it is advantageously possible to provide for an indirect transmission of such capability information, especially via using a radio access network inventory and capability network function RANICNF.

As a further alternative realization (between, on the one hand, a strictly direct communication or transmission of such capability information-directly from one radio access network node to another radio access network node—, and, on the other hand, a strictly centralized or service-based indirect communication or transmission of such capability information—e.g. via a single centralized database or network function or service for providing a repository functionality regarding such capability information), a central database entity or functionality might also be central to only a group of radio access network nodes, e.g. a group of radio access network nodes corresponding to one base station entity or to one gNB.

According to the present invention, it is furthermore advantageously possible and preferred that in case of a change of the capability of the specific first radio access network node, a modified capability information is sent by the specific first radio access network node, especially via a further capability indication message,

wherein especially the capability indication message and/or the further capability indication message comprises different sets of capability information, wherein each different set of capability information represent a different capability state of the specific first radio access network node, wherein especially different capability states of the specific first radio access network node are dependent on at least one of the following:
the location of the specific first radio access network node,
a specific time interval or a repeating time interval, preferably during a day, or a week or a month or a year,
a local or general or network-wide parameter, especially related to the local or network-wide network load.

According to the present invention, it is thereby advantageously possible that exemplary embodiments of the inventive method are able to be performed in a flexible and efficient manner.

According to the present invention, it is furthermore advantageously possible and preferred that the capability indication message is sent using at least one out of the following interfaces or reference points:
the 3GPP Xn interface or reference point,
the 3GPP E1 interface or reference point,
the 3GPP F1 interface or reference point,
the ORAN E2 interface or reference point,
the ORAN A1 interface or reference point,
the ORAN OpenFronthaul CUS interface or reference point,
the ORAN OpenFronthaul M interface or reference point,
   thereby especially realizing a direct and/or automatic exchange of capability information between involved radio access network nodes and especially between the specific first and second radio access network node.

According to the present invention, it is thereby advantageously possible that exemplary embodiments of the inventive method are able to be performed in a flexible and efficient manner.

According to the present invention, it is furthermore advantageously possible and preferred that the capability information is sent and related to or indicating the capability of the specific first radio access network node relates to the communication and feature capabilities
in general or
regarding one or a plurality of specific interfaces or reference points, especially Uu and/or Xn and/or NG interfaces or reference points or any other logical interface involving the radio access network node.

According to the present invention, it is thereby advantageously possible that exemplary embodiments of the inventive method are able to be performed in a flexible and efficient manner.

According to the present invention, it is furthermore advantageously possible and preferred that the form or the data format of the capability information corresponds to at least one of the following forms or data formats:
ASN.1, Abstract Syntax Notation One,
XML, Extensible Markup Language,
JSON, JavaScript Object Notation.

According to the present invention, it is thereby advantageously possible that exemplary embodiments of the inventive method are able to be performed in a flexible and efficient manner.

According to the present invention, it is furthermore advantageously possible and preferred that radio access network nodes of the plurality of radio access network nodes, and especially the specific first and second radio access network nodes, correspond to or realize one functionality or a plurality of functionalities of the following:
radio access coordinator unit,
base station centralized unit,
base station distributed unit,
base station radio unit,
   wherein especially such functionality or such functionalities are able to be related to or processing one out of the following:
user plane messages or user plane communication,
control plane messages or control plane communication, or
both user plane and control plane messages or user plane and control plane communication.

According to the present invention, it is thereby advantageously possible that exemplary embodiments of the inventive method are able to be performed in a flexible and efficient manner.

Furthermore, the present invention relates to a system or to a telecommunications network for operating the telecommunications network comprising a radio access network,

wherein the radio access network comprises a plurality of radio access network nodes that are able to interact in order to provide communication services to user equipments being connected to or served by the telecommunications network,
wherein the radio access network nodes realize, at least partly, radio access coordinator unit functionalities and/or base station functionalities,
wherein, in order to operate the telecommunications network and/or the radio access network and in order for a specific first radio access network node and a specific second radio access network node interacting with each other, the system or telecommunications network is configured such that:
the specific first radio access network node sends a capability indication message, the capability indication message comprises capability information related to or indicating the capability of the specific first radio access network node,
the specific second radio access network node receives capability information related to the specific first radio access network node.

Additionally, the present invention relates to a program comprising a computer readable program code which, when executed on a computer or on a specific first radio access network node or on a specific second radio access network node or on a central database entity or functionality, especially a radio access network inventory and/or capability network function, or in part on the specific first radio access network node and/or in part on the specific second radio access network node and/or in part on the central database entity or functionality, especially the radio access network inventory and/or capability network function, causes the computer or the specific first radio access network node or the specific second radio access network node or the central database entity or functionality, especially the radio access network inventory and capability network function, to perform exemplary embodiments of the inventive method.

Still additionally, the present invention relates to a computer-readable medium comprising instructions which, when executed on a computer or on a specific first radio access network node or on a specific second radio access network node or on a central database entity or functionality, especially a radio access network inventory and/or capability network function, or in part on the specific first radio access network node and/or in part on the specific second radio access network node and/or in part on the central database entity or functionality, especially the radio access network inventory and/or capability network function, causes the computer or the specific first radio access network node or the specific second radio access network node or the central database entity or functionality, especially the radio access network inventory and capability network function, to perform exemplary embodiments of the inventive method.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

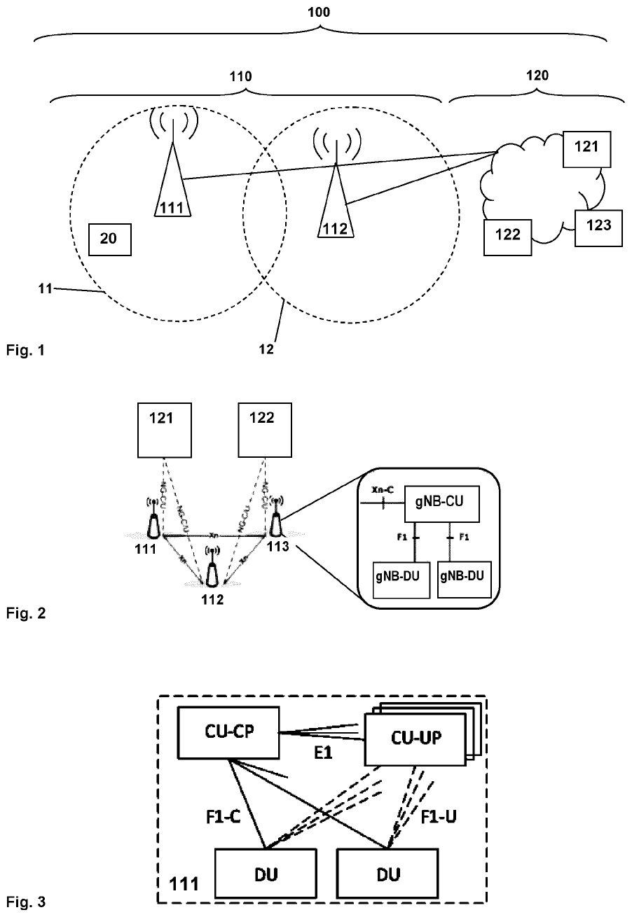

In FIG. 1, a telecommunications network 100 comprising an access network 110, and a core network 120 is schematically shown. The telecommunications network 100 or also mobile communication network 100 may be realized as a cellular network or cellular mobile communication network 100. The telecommunications network 100, especially the core network 120, may comprise a number of network functions or services 121, 122, 123. Examples of such network functions or services 121, 122, 123 include, e.g., an access and mobility management function, AMF, and/or a user plane function, UPF—especially in case of a 5G telecommunications network, in which case the core network 120 might also be called a 5G core (system) and the access network 110 or radio access network 110 a next-generation radio access network, NG-RAN. The access network 110 comprises a plurality of radio cells 11, 12, i.e. geographical areas served, respectively, by base station entities. In the exemplary situation or scenario shown in FIG. 1, a first base station entity 111 generates or is associated with or spans the first radio cell 11, and a second base station entity 112 generates or is associated with or spans the second radio cell 12. The base station entities 111, 112 may realize gNB functionality or next-generation gNB functionality. The telecommunications network 100 may be connected to a plurality of user equipments 20 (or, rather, the user equipments 20 are connected to the telecommunications network 100), one of which is schematically shown in FIG. 1.

FIG. 1 primarily shows the simple situation that the user equipment 20 is connected to its home network 100, especially its home public land mobile network, i.e. the telecommunications network 100 represented in FIG. 1 corresponds to the home network of the user equipment 20. However, the telecommunications network 100 (to which the user equipment 20 is connected, or, rather, to whose radio access network 120 the user equipment 20 is connected) might also correspond to a visited network or visited public land mobile network, and the home network or home public land mobile network of the user equipment 20 would, in this case, correspond to another telecommunications network connected to the telecommunications network 100.

According to the present invention, the network nodes of the radio access network 110 (or the functionality of the radio access network 110) might be realized in a rather disaggregated manner (or disaggregated radio access network architecture), via a plurality of radio access network nodes that are able to interact in order to provide communication services to the user equipment 20 (or, rather, also to other user equipments not explicitly shown in FIG. 1) being connected to or served by the telecommunications network 100.

An example of such a disaggregated realization of the radio access network 110 is schematically shown in FIG. 2, which especially illustrates different interfaces or reference points between network nodes or parts of the core network 120 of the telecommunications network 100 as well as network nodes or parts of the radio access network 110 (radio access network nodes) of the telecommunications network 100: FIG. 2 exemplarily and schematically shows a first network function or service 121 of the core network 120 and a second network function or service 122 of the core network 120. The first and second network function or service 121, 122 might, e.g., correspond to an access and mobility management function, AMF, and/or to a user plane function, UPF. Furthermore, FIG. 2 exemplarily and schematically shows the first base station entity 111, the second base station entity 112, and a third base station entity 113. The base station entities 111, 112, 113 are connected:
with each other via (or using) a (respective) Xn interface or reference point (potentially split into an Xn-C (Xn control plane) interface or reference point and/or an Xn-U (Xn user plane) interface or reference point), and
towards the first and/or second network function or service 121, 122—via (or using) a (respective) NG-C (NG control plane) interface or reference point and/or a NG-U (NG user plane) interface or reference point.
   When a disaggregated realization of the radio access network 110 is used, the base station entities 111, 112, 113 might be furthermore split, as schematically shown, in FIG. 2, for the example of the third base station entity 113: According to one separation, the gNB (or base station entity) functionality might be split into a central (or centralized) unit (gNB-CU) functionality and a distributed unit (gNB-DU) functionality, with an F1 interface or reference point between the gNB centralized unit (CU) and the gNB distributed unit (DU). Of course, the other base station entities 111, 112 might also be split analogously. Additionally, a further split, or according to a further separation, the gNB centralized unit (CU) (and/or the gNB distributed unit, DU) might be split up as shown in FIG. 3 which shows an example of the first base station entity 111, being split up and representing different functional entities or functionalities (or radio access network nodes) of the base station entity 111 in order to provide communication services to user equipments 20 connected to or served by the telecommunications network 100: Especially, the gNB centralized unit (CU) might be split up in a gNB centralized unit control plane (CU-CP) and a gNB centralized unit user plane (CU-UP)—with an E1 interface or reference point in between. In the exemplary embodiment shown in FIG. 3, the base station entity 111 or gNB comprises two gNB distributed units (DU), wherein each of these gNB distributed units (DU) is, respectively, connected to the gNB centralized unit control plane (CU-CP) via an F1-C (F1 control plane) interface or reference point, and to the gNB centralized unit user plane (CU-UP) via an F1-U (F1 user plane) interface or reference point. Likewise, the gNB distributed unit (DU) might also be split up into a control plane entity (or radio access network node) and a user plane entity (or radio access network node). Further elements of a disaggregated radio access network 110 might comprise at least one of the following local or physical nodes: A Radio Unit (RU), a none Realtime Radio Intelligent Controller (non-RT RIC) or a Near Realtime Radio Intelligent Controller (NearRT-RIC)—especially such nodes or entities according to the respective O-RAN specification.

Hence, via such disaggregation—within the radio access network architecture and especially within 5G, i.e. the disaggregation of radio access network nodes (especially the base station entity functionality), and specifically the gNB—, a more flexible mix and match of different components (radio access network nodes) is possible; however, as a consequence of such disaggregation or split of or into radio access network nodes, a higher number of different kinds of interfaces or reference points results in such a next-generation radio access network, NG-RAN, implementation.

In the context of the open radio access network, O-RAN alliance, further functional disaggregation (with the introduction of further related interfaces or reference points) is proposed.
However, with more interfaces or reference points (i.e. a higher number of different kinds of interfaces or reference points) more network coordination between radio access network nodes is required, which is not the case with a single vendor monolithic radio access network implementation.

As already mentioned, in conventional telecommunications networks 100 or mobile communication networks, the classical approach is that each (monolithic) vendor of the next-generation radio access network (NG-RAN) supplies their own proprietary operation and maintenance system (O&M system). As a consistent configuration between the different neighboring nodes of the next-generation radio access network is prerequisite for error-free interworking and consistent behavior across vendor boundaries in real network deployments, there is the requirement, e.g. upon the respective mobile network operator, to assure such consistency among the different radio access network nodes of the considered telecommunications network; this may involve the need to integrate and test the functionalities of radio access network nodes of different vendors and to perform a consistent configuration in the different (e.g., vendor-specific) O&M systems.

Also in the context of the open network automation platform (ONAP), the responsibility for ensuring consistency (regarding the interworking of different network nodes, especially of or associated with the radio access network, provided by different vendors) lies with the mobile network operators.
This represents a considerable burden on the mobile network operators.

According to the present invention, a radio access network node capability coordination is provided such that feature/functionality support information of the NG-RAN on a per interface basis is possible (either on a per interface node pair or centrally available), so that the communicating radio access network nodes or NG-RAN nodes are aware of each (other) node's capabilities related to the communication via the respective interface, especially in a dynamically changing network topology.

Hence, according to the present invention, a flexible direct information exchange between involved NG-RAN nodes—about the features the different nodes support—is provided. The evolution of 3GPP radio technologies adds hundreds of new user equipment features and/or network features release by release, whose manual configuration represents an always higher burden. Also, new concepts such as small cells, moving nodes (relays, IABs) and non-public-networks (NPN), including dynamic non-stationary topologies (e.g. NTN) require continuous changes to the network topology compared to the quasi stationary network setups known in rather conventional telecommunications networks.

Therefore, the present invention provides a dynamic capability exchange over different interfaces (between radio access network nodes realizing, at least partly, radio access coordinator unit functionalities and/or base station functionalities) in a disaggregated radio access network.

According to the present invention, in order to operate the telecommunications network 100 and/or the radio access network 110 and in order for a specific first radio access network node and a specific second radio access network node interacting with each other, the method comprises the steps of:
in a first step, the specific first radio access network node sends a capability indication message, the capability indication message comprises capability information related to or indicating the capability of the specific first radio access network node, and
in a second step, the specific second radio access network node receives capability information related to the specific first radio access network node.

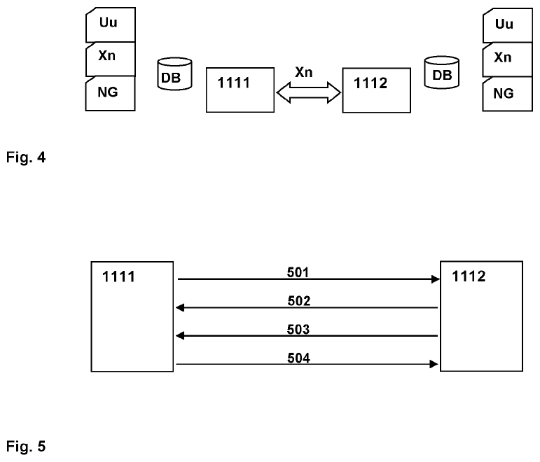

This is exemplarily shown in FIGS. 4 and 5 which schematically illustrate different communication situations between two considered radio access network nodes of the radio access network 110 of the telecommunications network 100: A first radio access network node 1111 and a second radio access network node 1121 communicate with each other (directly or indirectly) using, e.g., the Xn interface or reference point, and exchange capability information. These first and second radio access network nodes 1111, 1121 are hereinafter also called specific first radio access network node 1111 and specific second radio access network node 1121, respectively. In the situation or scenario represented in FIG. 4, capability information (regarding the specific first radio access network node 1111) is to be transmitted to the specific second radio access network node 1121: the specific first radio access network node 1111 sends a capability indication message, the capability indication message comprises capability information related to or indicating the capability of the specific first radio access network node 1111, hereafter, the specific second radio access network node 1121 receives the capability information related to the specific first radio access network node 1111. In FIG. 4, both the specific first and second radio access network nodes 1111, 1121 are shown to comprise (or to be associated or assigned to) databases or database entities DB in order to store capability information (of the respective other, or neighboring network nodes); especially, such capability information are stored, or organized,—especially as part of such databases or data base entities DB—according to or relating to different interfaces or reference points, used by such radio access network nodes; FIG. 4 schematically and exemplarily shows such capability information regarding the Uu, Xn, and NG interfaces or reference points.

Especially, in case of a direct communication (or exchange of capability information) between the specific first and second radio access network nodes 1111, 1121 (as shown in FIGS. 4 and 5), the capability indication message sent by the specific first radio access network node 1111 (in the first step) might be directly received (in the second step) by the specific second radio access network node 1121, i.e. as part of the second step, the specific second radio access network node 1121 receives the capability indication message sent by the specific first radio access network node 1111 (in the first step).
Especially, the capability indication message is able to be sent, by the specific first radio access network node 1111, upon detecting the presence of the specific second radio access network node 1121 or as a generic multicast message or as a broadcast message, especially periodically.
Hence, FIG. 4 represents a possible realization of the required database and the information exchange (between radio access network nodes) according to the present invention; especially, decentralized databases DB are used in either each involved node or in areas or for each involved NG-RAN vendor. It is proposed to structure the databases on a per interface relation, i.e. Uu features|Xn features|NG features.

The example or situation of a direct communication (or exchange of capability information) is also schematically and exemplarily shown in FIG. 5: In a first processing step 501, the specific first radio access network node 1111 transmits the capability indication message to the specific second radio access network node 1121 (i.e. thereby realizing the first and second steps of an exemplary embodiment of the inventive method), and in a second processing step 502, the specific second radio access network node 1121 sends a response message, e.g. an acknowledgement message, back to the specific first radio access network node 1111. FIG. 5 furthermore exemplarily shows a transmission of capability information in the inverse direction, i.e. from the specific second radio access network node 1121 towards the specific first radio access network node 1111: In a third processing step 503, the specific second radio access network node 1121 transmits a further capability indication message to the specific first radio access network node 1111 (i.e. thereby also realizing the first and second steps of an exemplary embodiment of the inventive method, albeit with exchanged roles of the specific first and second radio access network nodes 1111, 1121), and in a fourth processing step 504, the specific first radio access network node 1111 sends a further response message, e.g. an acknowledgement message, back to the specific second radio access network node 1121. The exchange of capability information shown in FIG. 5 is, e.g., realized at node setup of either the specific first or second (or both) radio access network nodes 1111, 1121. Hence, FIG. 5 shows an exemplary message exchange between two radio access network nodes, e.g. at communication path setup. In the example the specific first radio access network node 1111 sends the NG-RAN CAPBILITY INDICATION message to the specific second radio access network node 1121, which stores the conveyed information in the decentralized database DB for this communication relation and acknowledges the successful reception and storage of the information with a ACK message (NG-RAN CAPBILITY INDICATION ACKNOWLEDGEMENT).

The structure of the NG-RAN CAPBILITY INDICATION message especially comprises entries defined or structured (clustered) per interface relation; the formats of the table entries in the databases DB and/or in the capability indication messages especially follow a standardized approach; e.g. the structure can be any well-known data format from ASN.1 via XML to JSON formats.

According to another scenario or possibility to transmit (or to exchange) the capability information, the specific second radio access network node 1121 sends, prior to the first step, a capability indication request message to the specific first radio access network node 1111, the it is only in response to such a capability indication request message (received from the specific second radio access network node 1121) that the specific first radio access network node 1111 sends (as part of the first step) the capability indication message.

According to still another scenario or possibility to transmit the capability information, a central database entity (not represented in the Figures) is used: As part of the first step, (i.e. as a result of the specific first radio access network node 1111 sending the capability indication message), the central database entity or functionality receives the capability indication message sent by the specific first radio access network node 1111; as part of the second step, the capability information related to the specific first radio access network node 1111 is received, by the specific second radio access network node 1121, from the central database entity or functionality. Preferably, the central database entity or functionality is or corresponds to a radio access network inventory and/or capability network function.

Especially according to the present invention, in case of a change of the capability of the specific first radio access network node 1111, a modified capability information is sent by the specific first radio access network node 1111, especially via a further capability indication message.

The capability indication message and/or the further capability indication message might comprise different sets of capability information, wherein each different set of capability information represent a different capability state of the specific first radio access network node 1111.
Especially, different capability states of the specific first radio access network node 1111 are dependent on at least one of the following:
the location of the specific first radio access network node 1111,
a specific time interval or a repeating time interval, preferably during a day, or a week or a month or a year,
a local or general or network-wide parameter, especially related to the local or network-wide network load.

The specific first radio access network node 1111 and the specific second radio access network node 1121 considered in FIGS. 4 and 5 are meant only as examples of arbitrary network nodes of the telecommunications network 100, especially of the radio access network 110, i.e. such radio access network nodes may realize, at least partly, radio access coordinator unit functionalities and/or base station functionalities. This is, e.g. the case for the following radio access network nodes: gNB distributed unit (control plane and/or user plane) DU-CP/DU-UP, gNB centralized unit (control plane and/or user plane) CU-CP/CU-UP, gNB remote unit (control plane and/or user plane) RU-CP/RU-UP, near real-time radio access network intelligent controller (near-RT RAN RIC), non real-time radio access network intelligent controller (non-RT RAN RIC)—especially such nodes or entities according to the respective O-RAN specification.

According to the present invention, the specific first radio access network node 1111 might especially correspond to such a part or component of the first base station entity 111, and the specific second radio access network nodes 1121 might especially correspond to such a part or component of the second base station entity 112; however, other scenarios and situations are likewise possible according to the present invention, especially also the case that the specific first radio access network node 1111 and the specific second radio access network node 1121 correspond to different parts or components of one base station entity, e.g. the first base station entity 111, especially in case the such different components or parts of one and the same base station entity are provided by different vendors—and then need to be coordinated, as parts of the telecommunications network 100, in order to provide communication services to user equipments 20 being connected to or served by the telecommunications network 100.

Hence, the present invention provides for a dynamic exchange of capability information over interfaces in a disaggregated radio access network.

Especially, feature/functionality support information are provided of the NG-RAN components (i.e. the plurality of radio access network nodes) on a per interface basis, either on a per interface node pair or centrally using a central database entity, so that the communicating radio access network (NG-RAN) nodes are aware of each node's capabilities (i.e. aware of the capabilities of the respective other, or neighboring, radio access network nodes) related to the communication via the respective interface, especially in a dynamically changing network topology.

According to the present invention, this is able to be achieved via each related (radio access network) node can be pulled by the other related (radio access network) node about the (radio access network) node's related communication and feature capabilities in general or for the related interface, e.g. via an NG-RAN capability query. Especially, this is able to be realized by using 3GPP Xn or O-RAN E2-interface protocols which need to be extended in this direction.

Furthermore (alternatively or cumulatively to the capability information being pulled by other radio access network nodes), a transmission of capability information is possible using a periodic node capability broadcast or multicast via the respective interface by each involved (radio access network) node, e.g. via an NG-RAN capability announcement. Furthermore (alternatively or cumulatively to pulling the capability information, or to transmit, broadcast or multicast the capability information), a central database is able to be used where the (radio access network) node's capabilities are stored and made available for usage of this information by other related (radio access network) nodes for the respective interface.
This is also able to be realized by introduction of a service based architecture (SBA) in the radio access network: Especially, a radio access network inventory and capability network function” (RANICNF) is then needed to be introduced; e.g., at registration, each (radio access network) node then populates a database entity of such a RANICNF with its capability information or pieces of capability information (or sets of capability information, wherein each different set of capability information represent a different capability state of the respective (radio access network) node) per interface or in general also related to Uu relevant capabilities (i.e. relevant regarding communication with the user equipment 20) and the corresponding (neighboring) (radio access network) nodes, utilizing this interface, would query the neighboring (radio access network) node's capability from the RANICNF on setting up the node and establishment of an interface connection between neighboring (NG-RAN) nodes.

As a baseline for the definition of the functionalities supported in the related NG-RAN node could be the information about capabilities of user equipments being defined in 3GPP TR 38.822 already for functionality which is related to the Uu interface of the NG-RAN. Based in this information exchange the source NG-RAN node could select a target NG-RAN node in case of mobility of a device or for load balancing reasons taking into account the Uu related neighboring node's capabilities. E.g., if a user equipment 20 is currently involved in an optimized XR session in the source node and there is a need to perform a handover while there are two neighboring nodes which could take over this user equipment connection, but just one of the node supports the XR optimization, in conventional telecommunications networks, the source NG-RAN node has no possibility to select the right target node (i.e. having the required functionality or capability) as the selection principles may be statically pre-defined and radio related measurements (e.g. signal strength) is the main decision criteria. As with more diverse services and a heterogeneous dynamic network environment such additional decision criteria become more relevant.

According to the present invention, it is preferred to use (or to provide the possibility to use) different feature sets, such as, e.g., at least one out of the following:
a user equipment-related feature support (e.g. to be used by the NG-RAN—or radio access network nodes thereof—via the Uu interface), especially based on definitions of features in 3GPP TR 38.822;
NG-RAN internal features (e.g. energy saving, SON, ML/AI functionality etc) to be used via the Xn interface;
5GC related functionality which is required between core network functions and radio access network functions, to be used via the NG2 or NG3 interface; examples are functionalities requiring e2e support such as network slicing, non-terrestrial network (NTN), network sharing, non-public-networks NPN (“Campus Networks”) and so on.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for operating a telecommunications network comprising a radio access network, wherein the radio access network comprises a plurality of radio access network nodes that are configured to interact in order to provide communication services to user equipments connected to or served by the telecommunications network,
wherein the radio access network nodes realize, at least partly, radio access coordinator unit functionalities and/or base station functionalities,
wherein, in order to operate the telecommunications network and/or the radio access network and in order for a specific first radio access network node and a specific second radio access network node to interact with each other, the method comprises the following steps:
in a first step, the specific first radio access network node sends a capability indication message, wherein the capability indication message comprises capability information related to or indicating a capability of the specific first radio access network node; and
in a second step, the specific second radio access network node receives the capability information.

2. The method according to claim 1, wherein, as part of the second step, the specific second radio access network node receives the capability indication message from the specific first radio access network node.

3. The method according to claim 1, wherein, as part of the first step, a central database entity or functionality receives the capability indication message from the specific first radio access network node; and
wherein, as part of the second step, the capability information is received by the specific second radio access network node, from the central database entity or functionality.

4. The method according to claim 1, wherein in case of a change of the capability of the specific first radio access network node, modified capability information is sent by the specific first radio access network node.

5. The method according to claim 1, wherein the capability indication message is sent using at least one out of the following interfaces or reference points:
a 3GPP Xn interface or reference point, or
an ORAN E2 interface or reference point.

6. The method according to claim 1, wherein the capability information relates to the communication and feature capabilities regarding one or a plurality of specific interfaces or reference points.

7. The method according to claim 1, wherein the form or the data format of the capability information corresponds to at least one of the following forms or data formats:
Abstract Syntax Notation One (ASN.1),
Extensible Markup Language (XML), or
JavaScript Object Notation (JSON).

8. The method according to claim 1, wherein radio access network nodes of the plurality of radio access network nodes correspond to or realize one or more functionalities of the following:
radio access coordinator unit,
base station centralized unit,
base station distributed unit, or
base station radio unit.

9. A system for operating a telecommunications network comprising a radio access network, wherein the radio access network comprises a plurality of radio access network nodes that are configured to interact in order to provide communication services to user equipments connected to or served by the telecommunications network,
wherein the radio access network nodes realize, at least partly, radio access coordinator unit functionalities and/or base station functionalities,
wherein the system comprises:
a specific first radio access network node; and
a specific second radio access network node;
wherein the specific first radio access network node is configured to send a capability indication message, wherein the capability indication message comprises capability information related to or indicating the capability of the specific first radio access network node; and
wherein the specific second radio access network node is configured to receive the capability information.

10. (canceled)

11. A non-transitory computer-readable medium comprising instructions for operating a telecommunications network comprising a radio access network, wherein the radio access network comprises a plurality of radio access network nodes that are configured to interact in order to provide communication services to user equipments connected to or served by the telecommunications network.
wherein the radio access network nodes realize, at least partly, radio access coordinator unit functionalities and/or base station functionalities,
wherein the processor-executable instructions, when executed, facilitate performance of the following steps:
in a first step, the specific first radio access network node sends a capability indication message, wherein the capability indication message comprises capability information related to or indicating a capability of the specific first radio access network node; and
in a second step, the specific second radio access network node receives the capability information.

12. The method according to claim 2, wherein the specific second radio access network node sends, prior to the first step, a capability indication request message to the specific first radio access network node.

13. The method according to claim 12, wherein the specific first radio access network node sends the capability indication message upon detecting the presence of the specific second radio access network node or as a generic multicast message or as a broadcast message.

14. The method according to claim 13, wherein the specific first radio access network node sends the capability indication message periodically.

15. The method according to claim 3, wherein the central database entity or functionality is or corresponds to a radio access network inventory and/or capability network function.

16. The method according to claim 4, wherein the modified capability information is sent by the specific first radio access network node via a further capability indication message.

17. The method according to claim 16, wherein the capability indication message and/or the further capability indication message comprise different sets of capability information, wherein each different set of capability information represents a different capability state of the specific first radio access network node.

18. The method according to claim 17, wherein different capability states of the specific first radio access network node are dependent on at least one of the following:
the location of the specific first radio access network node,
a specific time interval or a repeating time interval, or
a local or general or network-wide parameter.

19. The method according to claim 18, wherein the local or general or network-wide parameter is related to a local or network-wide network load.

20. The method according to claim 6, wherein the plurality of specific interfaces or reference points comprise Uu and/or Xn and/or NG interfaces or reference points.

21. The method according to claim 8, wherein the one or more functionalities are configured to be related to or process one out of the following:
user plane messages or user plane communication,
control plane messages or control plane communication, or
both user plane and control plane messages or user plane and control plane communication.
